(19) United States
(12) Patent Application Publication
(10) Pub. No.: US 2024/0329008 A1
(43) Pub. Date: Oct. 3, 2024

(54) PORTABLE ROLLING SENSOR ARRAY PROBE

(71) Applicant: Verifi Technologies, LLC, Waco, TX (US)

(72) Inventors: Benjamin M. Blandford, Waco, TX (US); David A. Jack, Waco, TX (US); Irrtisum Khan, Waco, TX (US); Gary Georgeson, Tacoma, WA (US); Nathaniel J. Blackman, Hewitt, TX (US)

(73) Assignee: Verifi Technologies, LLC, Waco, TX (US)

(21) Appl. No.: 18/591,897

(22) Filed: Feb. 29, 2024

Related U.S. Application Data
(60) Provisional application No. 63/449,466, filed on Mar. 2, 2023.

(51) Int. Cl. G01N 29/265; G01N 29/04; G01N 29/22; G01N 29/24; G01N 29/28

(52) U.S. Cl. CPC G01N 29/265; G01N 29/043; G01N 29/226; G01N 29/28; G01N 29/2437; G01N 2291/0289; G01N 2291/106

(57) ABSTRACT

A sensor array housing device includes an enclosed couplant housing section between a linear array of transducers or coils and a test object. The linear array is particularly suited for sectoral scanning of a test object. Interior surfaces of the couplant housing section include a plurality of ridges for mitigating the impact of reflected side lobes on scan data. The sensor array housing device includes a plurality of retained articulating balls, configured to allow the sensor array housing device to move omnidirectionally across a surface of the test object.

### CROSS-REFERENCE TO RELATED APPLICATIONS

This application is related to and claims priority from the following US patents and patent applications: this application claims priority from and the benefit of U.S. Provisional Patent Application No. 63/449,466, filed Mar. 2, 2023, which is incorporated herein by reference in its entirety.

### BACKGROUND OF THE INVENTION

### 1. Field of the Invention

The present invention relates to array probe devices, and more particularly to phased array probe devices able to omnidirectionally articulate about the surface of a test object.

### 2. Description of the Prior Art

It is generally known in the prior art to provide phased array ultrasonic testing systems, which are formed from arrays of individual piezoelectric elements, to nondestructively scan test objects to identify flaws, features, or qualities of the test objects. By applying different focal laws, or rules for timing the firing of each individual element in the array, an ultrasonic beam produced by the phased array is able to be angled or focused at different depths.

Prior art devices have placed sensor array elements within roller probes, such as the ROLLERFORM produced by Olympus. Alternatively, sensor array systems have been used to scan parts within immersion tanks.

Prior art patent documents include the following:

U.S. Pat. No. 9,470,658 for Self-contained holonomic tracking method and apparatus for non-destructive inspection by inventors Troy et al., filed Mar. 12, 2013 and issued Oct. 18, 2016, discloses a self-contained, holonomic motion tracking solution for supplementing the acquisition of inspection information on the surface of a structure, thereby enabling the real-time production of two-dimensional images from hand-held and automated scanning by holonomic-motion of non-destructive inspection (NDI) sensor units (e.g., NDI probes). The systems and methods disclosed enable precise tracking of the position and orientation of a holonomic-motion NDI sensor unit (hand-held or automated) and conversion of the acquired tracking data into encoder pulse signals for processing by a NDI scanning system.

U.S. Pat. No. 11,367,201 for System and method for continual localization of scanner using non-destructive inspection data by inventors Troy et al., filed Sep. 24, 2019 and issued Jun. 21, 2022, discloses systems and methods for tracking the location of a non-destructive inspection (NDI) scanner using scan data converted into images of a target object. Scan images are formed by aggregating successive scan strips acquired using one or two one-dimensional sensor arrays. An image processor constructs and then compares successive partially overlapping scan images that include common features corresponding to respective structural features of the target object. The image processor is further configured to compute a change in location of the NDI scanner relative to a previous location based on the respective positions of those common features in the partially overlapping scan images. This relative physical distance is then added to the previous (old) absolute location estimate to obtain the current (new) absolute location of the NDI scanner.

U.S. Pat. No. 10,955,310 for Vacuum-adhering apparatus for automated inspection of airfoil-shaped bodies with improved surface mounting by inventors Hafenrichter et al., filed Sep. 12, 2018 and issued Mar. 23, 2021, discloses a vacuum-adhering apparatus for automated non-destructive inspection (NDI) of airfoil-shaped bodies with improved surface mounting. The apparatus may be used to inspect the leading edge surface and other surfaces of a wind turbine blade, a helicopter rotor blade, or an aircraft wing. The apparatus includes a multiplicity of wheels and a multiplicity of omnidirectional rolling elements rotatably coupled to a flexible substrate made of semi-rigid material. The wheels are configured to enable omnidirectional motion of the flexible substrate. The apparatus further includes flexible vacuum seals supported by the flexible substrate and vacuum adherence devices that keep the wheels frictionally engaged on the surface of the airfoil-shaped body regardless of surface contour. The apparatus also includes a flexible sensor array attached to or integrally formed with the flexible substrate. The crawler vehicle is capable of adhering to and moving over a non-level surface while enabling the sensor array to acquire NDI scan data from the surface under inspection.

U.S. Pat. No. 9,464,754 for Automated mobile boom system for crawling robots by inventors Troy et al., filed Jun. 14, 2016 and issued Oct. 11, 2016, discloses a system comprising a multi-functional boom subsystem integrated with a holonomic-motion boom base platform. The boom base platform may comprise: Mecanum wheels with independently controlled motors; a pair of sub-platforms coupled by a roll-axis pivot to maintain four-wheel contact with the ground surface; and twist reduction mechanisms to minimize any yaw-axis twisting torque exerted on the roll-axis pivot. A computer with motion control software may be embedded on the boom base platform. The motion control function can be integrated with a real-time tracking system. The motion control computer may have multiple platform motion control modes: (1) a path following mode in which the boom base platform matches the motion path of the surface crawler (i.e., integration with crawler control); (2) a reactive mode in which the boom base platform moves based on the pan and tilt angles of the boom arm; and (3) a collision avoidance mode using sensors distributed around the perimeter of the boom base platform to detect obstacles.

U.S. Pat. No. 11,007,635 for Gravity compensation for self-propelled robotic vehicles crawling on non-level surfaces by inventors Georgeson et al., filed Jul. 25, 2018 and issued May 18, 2021, discloses an apparatus and methods for providing gravity compensation to a cable-suspended, vacuum-adhered, tool-equipped crawler vehicle traveling along and following the contour of a non-level surface during the execution of an automated maintenance operation. One technical feature shared by multiple embodiments of the gravity-compensating systems is that a cable spool is operated to wind a portion of the cable from which the vacuum-adhered crawler vehicle is suspended to generate a tensile force that counteracts a gravitational force being exerted on the crawler vehicle during movement. Rotation of the cable spool may be driven by a motor or by a tensioning spring.

U.S. Pat. No. 9,863,919 for Modular mobile inspection vehicle by inventors Zanini et al., filed Nov. 25, 2014 and issued Jan. 9, 2018, discloses a modular inspection vehicle having at least first and second motion modules. The first and second motion modules are connected to a chassis. The first motion module includes a first wheel mounted to the chassis. The second motion module includes second wheel mounted to the chassis, the second wheel being at an angle to the first wheel. The vehicle further includes a navigation module configured to collect position data related to the position of the vehicle, an inspection module configured to collect inspection data related to the vehicle's environment, and a communication module configured to transmit and receive data. The vehicle can also include a control module configured to receive the inspection data and associate the inspection data with received position data that corresponds to the inspection data collect at a corresponding position for transmission via the communication module.

U.S. Pat. No. 8,738,226 for Holonomic motion vehicle for travel on non-level surfaces by inventors Troy et al., filed Aug. 16, 2011 and issued May 27, 2014, discloses holonomic-motion ground vehicles (i.e., mobile platforms) that are capable of controlled movement across non-level surfaces, while carrying one or more non-destructive inspection sensors or other tools. The mobile platform comprises a frame having four (or a multiple of four) Mecanum wheels, each wheel driven by a respective independently controlled motor, and further having a plurality (e.g., two) of independently controlled suction devices. The Mecanum wheels enable holonomic motion, while the suction devices facilitate sufficiently precise control of motion on non-level surfaces.

US Patent Publication No. 2021/0089817 for Method for Tracking Location of Two-Dimensional Non-Destructive Inspection Scanner on Target Object Using Scanned Structural Features by inventors Hafenrichter et al., filed Sep. 24, 2019 and published Mar. 25, 2021, discloses systems and methods for tracking the location of a non-destructive inspection (NDI) scanner using images of a target object acquired by the NDI scanner. The system includes a frame, an NDI scanner supported by the frame, a system configured to enable motorized movement of the frame, and a computer system communicatively coupled to receive sensor data from the NDI scanner and track the location of the NDI scanner. The NDI scanner includes a two-dimensional (2-D) array of sensors. Subsurface depth sensor data is repeatedly (recurrently, continually) acquired by and output from the 2-D sensor array while at different locations on a surface of the target object. The resulting 2-D scan image sequence is fed into an image processing and feature point comparison module that is configured to track the location of the scanner relative to the target object using virtual features visible in the acquired scan images.

U.S. Pat. No. 11,098,854 for Magnetic crawler vehicle with passive rear-facing apparatus by inventors Zanini et al., filed Sep. 26, 2019 and issued Aug. 24, 2021, discloses a robotic vehicle for traversing surfaces. The vehicle is comprised of a front chassis section including a magnetic drive wheel for driving and steering the vehicle and a front support point configured to contact the surface. The vehicle also includes a rear chassis section supporting a follower wheel. The front and rear chassis sections are connected by joints including a hinge joint and a four-bar linkage. The hinge is configured to allow the trailing assembly to move side-to-side while the four-bar linkage allows the trailing assembly to move up and down relative to the front chassis. Collectively, the rear facing mechanism is configured to maintain the follower wheel in contact with and normal to the surface and also maintains the front support in contact with the surface and provides stability and maneuverability to the vehicle while traversing surfaces regardless of surface curvature and vehicle orientation.

U.S. Pat. No. 10,634,123 for Apparatus and methods for maintenance of wind turbine blades by inventors Georgeson et al., filed Dec. 14, 2017 and issued Apr. 28, 2020, discloses systems and methods for the automated non-destructive inspection of wind turbine blades. A motor-driven track that conforms to the shape of the blade moves along its length. At each spanwise position, the motor-driven track is stopped and then while the motor-driven track is stationary, any one of various types of NDI sensors is moved along the track to collect inspection data on the structure. The track is either segmented or flexible in order to conform to the cross-sectional profile of the blade. In addition, tracking the spanwise motion of the motor-driven track along the blade is provided. Optionally, avoiding protrusions on the blade that may be in the way during scanning is provided.

U.S. Pat. No. 11,135,721 for Apparatus for providing an interactive inspection map by inventors Bryner et al., filed Nov. 13, 2020 and issued Oct. 5, 2021, discloses an apparatus for providing an interactive inspection map. An example apparatus for providing an interactive inspection map of an inspection surface may include an inspection visualization circuit to provide an inspection map to a user device in response to inspection data provided by a plurality of sensors operationally coupled to an inspection robot traversing the inspection surface, wherein the inspection map corresponds to at least a portion of the inspection surface. The apparatus may further include a user interaction circuit to interpret a user focus value from the user device, and an action request circuit to determine an action in response to the user focus value. The inspection visualization circuit may further update the inspection map in response to the determined action.

U.S. Pat. No. 9,909,918 for Ultrasonic scanning device having a fluid pad by inventor Valentin, filed Jul. 29, 2015 and issued Mar. 6, 2018, discloses an ultrasonic scanning device for scanning a turbine component. The device includes an ultrasonic transducer attached to a moveable fluid distribution block, wherein the block includes a block opening and an internal passageway for receiving a fluid. The device also includes a fluid pad having a fluid pad opening that is in fluid communication with the block opening, wherein the fluid pad and block openings form a channel that extends between the ultrasonic transducer and the turbine component. Fluid received by the internal passageway moves to the channel and forms a fluid column between the ultrasonic transducer and the turbine component that facilitates transmission of ultrasonic energy generated by the ultrasonic transducer. In addition, the device includes a control module for controlling operation of the ultrasonic transducer and an encoder for providing travel information to the control module for determining a position of the device relative to the turbine component.

U.S. Pat. No. 10,118,655 for Hinged vehicle chassis by inventors Outa et al., filed Dec. 21, 2017 and issued Nov. 6, 2018, discloses a robotic vehicle chassis. The robotic vehicle chassis includes a first chassis section, a second chassis section, and a hinge joint connecting the first and second chassis sections such that the first and second chassis sections are capable of rotation with respect to each other in at least a first direction. The vehicle includes a drive wheel mounted to one of the first and second chassis sections and an omni-wheel mounted to the other of the first and second chassis sections. The omni-wheel is mounted at an angle orthogonal with respect to the drive wheel. The hinge joint rotates in response to the curvature of a surface the vehicle is traversing.

U.S. Pat. No. 8,513,943 for Apparatus, system, and method for scanning a surface by inventors Gehlen et al., filed Aug. 24, 2010 and issued Aug. 20, 2013, discloses an apparatus, system, and method for maintaining normalcy of a sensor with respect to a structure. The apparatus includes a driving member, a driven member, and a sensor. The driving member includes a first engaging element and a second engaging element. The driven member includes a third engaging element and a fourth engaging element. The third engaging element of the driven member is engaged with the first engaging element of the driving member. The fourth engaging element of the driven member is engaged with the second engaging element of the driving member. The sensor is coupled to the driven member, which is rotatably drivable by the driving member. Engagement between the first and third engaging elements facilitates three-dimensional adjustment of the driven member relative to the driving member. Engagement between the second and fourth engaging elements facilitates co-rotation of the driving member and the driven member.

U.S. Pat. No. 7,375,514 for Flexible hand held MR scanning array for cracks/flaws by inventors Rempt et al., filed Nov. 1, 2005 and issued May 20, 2008, discloses a non-destructive testing device having an excitation coil with a plurality of conductor ribbons attached to a flexible membrane. A frame supports the membrane and incorporates wheels for translation across a surface to be inspected and resilient suspension for maintaining the membrane with the excitation coil and wheels in intimate contact with the surface, the membrane flexing to maintain contact with a smoothly curved surface as found in aircraft structures. A magnetoresitive (MR) array is supported within the frame inserted in the membrane to be in close proximity to the surface. The MR array detects the magnetic field resulting from the eddy currents created by the excitation coil for identification of cracks or features beneath the surface under inspection.

U.S. Pat. No. 8,813,567 for Low profile ultrasound inspection scanner by inventor Brignac, filed Dec. 10, 2012 and issued Aug. 26, 2014, discloses an inspection scanner that has a low profile construction designed to fit into tight spaces and inspect structures such as weld joints. Wheel frame assemblies carry a probe holder assembly with an ultrasonic (US) array that emits US beams through the structure and receives reflected sound waves. The probe holder assembly extends and US beam is angled away to inspect in tight locations. The wheel frame assemblies roll on wheels that drive an encoder. Encoder provides the specific locations for the received sound waves with respect to the weld. The locations and received sound waves are used to reconstruct a signal showing imperfections inside of structure. The wheels may be magnetic to hold it to the structure being inspected. A brake system may be employed to hold the inspection scanner at a given location.

U.S. Pat. No. 8,820,850 for Rolling element for the polydirectional travel of a vehicle, and vehicle having such a rolling element by inventors Moser et al., filed Jan. 19, 2012 and issued Sep. 2, 2014, discloses a rolling element for the polydirectional travel of a vehicle on a magnetically attractive underlying surface with a compact, robust and simple design such that the rolling element has a spherical element and at least one permanent magnet. The spherical element supports the at least one permanent magnet in such a way that the at least one permanent magnet maintains its spatial orientation when the spherical element rolls on the underlying surface, and the spherical element is held in contact against the underlying surface by the magnetic interaction of the at least one permanent magnet with the underlying surface.

U.S. Pat. No. 10,823,709 for Methods and apparatus for realigning and re-adhering a hanging crawler vehicle on a non-level surface by inventors Hafenrichter et al., filed Jul. 6, 2018 and issued Nov. 3, 2020, discloses an apparatus and methods for realigning and re-adhering a hanging tool-equipped crawler vehicle with respect to a non-level surface of a target object. When the cable-suspended crawler vehicle with suction devices is adhered to a non-level surface of a target object, it is possible for the crawler vehicle to detach from the surface and be left hanging from the end of the cable in a state. While hanging from the end of the cable in a misaligned state and not in contact with the target object, the crawler vehicle is unable to carry out a planned maintenance operation. Before the maintenance operation is resumed, the crawler vehicle is realigned with the surface of the target object using a turret, a rotating arm or a cam-shaped roll bar provided as equipment on the crawler vehicle and then re-adhered to the surface by activation of the suction devices.

U.S. Pat. No. 7,542,871 for Control for hand-held imaging array using computer mouse configuration by inventors Rempt et al., filed Oct. 31, 2005 and issued Jun. 2, 2009, discloses a hand held non-destructive testing device having a frame which supports an NDI sensor and incorporates means for translation across a surface to be inspected with position registration and resilient means for maintaining the sensor and the translation means in intimate contact with the surface. An ergonomic handle is mounted to the frame for manually controlled translation of the frame incorporates a plurality of control means for control of the sensor in scanning of the surface under inspection.

U.S. Pat. No. 10,866,213 for Eddy current probe by inventor Wekell, filed Oct. 26, 2018 and issued Dec. 15, 2020, discloses a flexible eddy current probe for non-destructive testing of a metallic object, the probe having a flexible printed circuit containing eddy current drive and sense coils and a rotary encoder configured to measure liner distance as the eddy current probe being scanned over the object. The probe features an encoder arm that adjustably connects a flexible eddy current sensor array to the rotary encoder.

U.S. Pat. No. 10,883,970 for Scanner magnetic wheel system for close traction on pipes and pipe elbows by inventors Spay et al., filed Oct. 24, 2018 and issued Jan. 5, 2021, discloses an ultrasound scanner assembly for inspection of pipes and pipe elbows comprising a frame and a wedge. Four wheels are attached to the frame, there being a front wheel pair and a rear wheel pair. In order to maintain stable positioning of the probe assembly while scanning, the wheels are magnetic, thereby establishing a magnetic stabilizing force between the wheels and the pipe or pipe elbow. The magnetic stabilizing force is larger for pipes of small diameter than for pipes of large diameter.

U.S. Pat. No. 9,176,099 for Variable radius inspection using sweeping linear array by inventors Motzer et al., filed May 8, 2012 and issued Nov. 4, 2015, discloses a method and apparatus for enabling ultrasonic inspection of a changing, insufficiently defined or unknown shape (e.g., a variable radius or a noncircular radius caused by the use of soft tooling) at a rate that meets production requirements. The apparatus comprises a linear ultrasonic array (i.e., sensor) incorporated in a toppler, which in turn is slidably supported by an oscillating sensor mechanism carried by a traveling trailer vehicle. As a result of this arrangement, the sensor can undergo a back-and-forth sweeping motion coupled with motion along the spar radius. The sensor is further able to displace radially relative to a sweep pivot axis and rotate (hereinafter “topple”) about a topple pivot axis. In this manner, the orientation of the sensor can adjust to the contour of the inspected surface as the sensor scans.

U.S. Pat. No. 9,291,603 for Inspection vehicle for the inspection of substantially cylindrical objects by inventors Thommen-Stamenkov et al., filed Sep. 9, 2011 and issued Mar. 22, 2016, discloses an inspection vehicle for inspecting a substantially cylindrical object composed of a magnetizable material including a chassis. A plurality of wheels is disposed on the chassis so as to be rotatable and is configured to move the chassis in a circumferential direction along an external surface of the cylindrical object, at least some of the plurality of wheels being motor-drivable. The plurality of wheels is disposed so as to provide a chassis clearance allowing a movement of the chassis over an obstruction on the external surface of the cylindrical object. A magnetic device is disposed on the chassis and is configured to hold the vehicle on the external surface of the cylindrical object.

U.S. Pat. No. 7,315,609 for Real-time X-ray scanner and remote crawler apparatus and method by inventors Safai et al., filed Jan. 24, 2005 and issued Jan. 1, 2008, discloses inspecting a structure with non-destructive x-ray inspection using probes magnetically coupled to opposing surfaces of the structure. An inspection device may be autonomous with a feedback-controlled motor and/or a positional encoder. An inspection device may include wireless operation for at least one probe. A display may be included to provide real-time visual images from an x-ray detector or an optical imager.

US Patent Publication No. 2022/0170889 for System and method for passive normalization of a probe by inventors Abdellatif et al., filed Nov. 30, 2020 and published Jun. 2, 2022, discloses a system and method passively normalizing an ultrasonic dry coupled wheel probe as the probe traverses a surface of a structure to inspect the structure, such as a flat structure or a curved pipe. At least a pair of arms are configured to passively maintain normalization of the probe in a detection direction normal to the surface.

U.S. Pat. No. 7,231,826 for Non-destructive inspection device for inspecting limited-access features of a structure by inventors Bossi et al., filed Jan. 7, 2004 and issued Jun. 19, 2007, discloses a non-destructive inspection device having an actuating portion and at least one inspecting portion. The inspecting portion(s) are magnetically coupled to the actuating portion so that the inspecting portion(s) may be moved into limited-access areas to inspect features of a structure. The inspecting portion(s) each include at least one inspection sensor that transmits and/or receives signals that, when processed, indicate defects in the features of the structure. The actuating portion may include a handle for manual movement of the inspection device, or alternatively may include a motorized drive wheel for motorized positioning of the inspection device. A positional encoder device, such as an encoder wheel or optical encoder, may also be included in the actuating portion or inspecting portion(s) to monitor the location of the inspection device for more accurate or informative inspection results.

US Patent Publication No. 2012/0060609 for Non-Destructive Inspection Scanning Apparatus And Non-Destructive Inspection Apparatus by inventors Fukutomi et al., filed May 28, 2010 and published Mar. 15, 2012, discloses a non-destructive inspection scanning apparatus and a non-destructive inspection apparatus which can cope with the size and shape of a structure, which is an inspection target, in which attachment to the structure is facilitated, and which can be reduced in size and cost are provided. A non-destructive inspection scanning apparatus that relatively moves a sensor head employed to detect a flaw in an inspection target (P) with respect to a test surface of the inspection target (P) includes a rod-shaped guide portion that is disposed at the inspection target (P) and that extends along a surface of the inspection target (P); a pair of wheels having a ring-like groove portion, which sandwiches the guide portion therein, at a circumferential surface that comes in contact with the inspection target (P); a suctioning portion that generates a suction force that presses the wheels against the inspection target (P); and a casing that holds the sensor head and to which the pair of wheels are attached so as to be rotatable about a rotation axis that extends in a direction that intersects a surface of the inspection target (P) to which the wheels come in contact.

U.S. Pat. No. 8,371,173 for Ultrasonic probe deployment device for increased wave transmission and rapid area scan inspections by inventors DiMambro et al., filed Sep. 20, 2011 and issued Feb. 12, 2013, discloses an ultrasonic probe deployment device in which an ultrasound-transmitting liquid forms the portion of the ultrasonic wave path in contact with the surface being inspected (i.e., the inspection surface). A seal constrains flow of the liquid, for example preventing the liquid from surging out and flooding the inspection surface. The seal is not rigid and conforms to variations in the shape and unevenness of the inspection surface, thus forming a seal (although possibly a leaky seal) around the liquid. The probe preferably is held in place to produce optimum ultrasonic focus on the area of interest. Use of encoders can facilitate the production of C-scan area maps of the material being inspected.

US Patent Publication No. 2022/0136815 for Tool for Precise Locating of Fasteners Under Coatings by inventors Rickless et al., filed Sep. 8, 2021 and published May 5, 2022, discloses a fastener locating tool equipped with a sensor head having one or more probes and a method for operating such a tool for precisely locating a fastener that is hidden or buried under a thick coating applied on a surface of a structure. The fastener locating tool may be manually or automatically operated. The fastener locating tool includes a platform having a central opening, means for temporarily attaching the platform to a coated surface, and a sensor head that may be easily mechanically coupled to and then later decoupled from the platform. Optionally, the fastener locating tool also includes a multi-stage positioning system with X and Y stages which may be used to adjust the position of the sensor head. The sensor head includes at least one probe which generates electrical signals indicating the presence of a fastener beneath a coating when the probe is within a detection range.

### SUMMARY OF THE INVENTION

The present invention relates to sensor array probe devices, and more particularly to phased array probe devices able to omnidirectionally articulate about the surface of a test object.

It is an object of this invention to provide a portable, highly-movable housing for an array of transducers.

In one embodiment, the present invention is directed to a sensor array housing device, including a stem, a transducer housing section, including an array of ultrasonic sensors, a couplant housing section, wherein the couplant housing section is filled with at least one coupling fluid, an articulating section, attached to a bottom end of the couplant housing section, including a plurality of omnidirectional wheels extending downwardly from the articulating section, wherein the couplant housing section includes a plurality of grooves extending inwardly from an interior surface of an interior chamber of the couplant housing section, wherein the stem is connected to the couplant housing section via one or more bolts or screws, wherein the transducer housing is positioned between the stem and the couplant housing section, wherein a bottom end of the couplant housing section includes an acoustic window, and wherein an interior chamber of the transducer housing section and the interior chamber of the couplant housing section are configured to form a shared hollow interior chamber.

In another embodiment, the present invention is directed to a sensor array housing system, including a scanning device, including a stem, a transducer housing section, including an array of ultrasonic sensors, a couplant housing section, wherein the couplant housing section is filled with at least one coupling fluid, an articulating section, attached to a bottom end of the couplant housing section, including a plurality of omnidirectional wheels extending downwardly from the articulating section, wherein the couplant housing section includes a plurality of grooves extending inwardly from an interior surface of an interior chamber of the couplant housing section, wherein the transducer housing is positioned between the stem and the couplant housing section; and wherein a bottom end of the couplant housing section includes an acoustic window, a robotic arm connected to the stem of the scanning device, and at least one user device in network communication with the scanning device and the robotic arm, wherein the robotic arm is configured to receive positioning commands from the at least one user device to position and move the scanning device for scanning a test object, and wherein the scanning device is configured to receive transducer operational commands from the at least one user device including parameters for operating the array of ultrasonic sensors.

In yet another embodiment, the present invention is directed to a method of nondestructive testing, including providing a scanning device, including a stem, a transducer housing section, including an array of ultrasonic sensors, a couplant housing section, wherein the couplant housing section is filled with at least one coupling fluid, an articulating section, attached to a bottom end of the couplant housing section, including a plurality of omnidirectional wheels extending downwardly from the articulating section, wherein the couplant housing section includes a plurality of grooves extending inwardly from an interior surface of an interior chamber of the couplant housing section, wherein a bottom end of the couplant housing section includes an acoustic window, and at least one user device transmitting commands to the array of ultrasonic sensors to begin a scan of a test object, the array of ultrasonic sensors, in response to the commands, transmitting ultrasonic waves through the at least one coupling fluid and through the acoustic window onto a test object, and the at least one user device transmitting positioning commands to a robotic arm attached to the scanning device, wherein the positioning commands cause the robotic arm to manipulate the physical positioning of the scanning device during the scan of the test object, wherein the ultrasonic waves have a wavelength equal to less than double a height of each of the plurality of grooves.

These and other aspects of the present invention will become apparent to those skilled in the art after a reading of the following description of the preferred embodiment when considered with the drawings, as they support the claimed invention.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A illustrates a perspective view of a sensor array housing device according to one embodiment of the present invention.

FIG. 1B illustrates a side sectional view of a sensor array housing device according to one embodiment of the present invention.

FIG. 1C illustrates a perspective exploded view of a sensor array housing device according to one embodiment of the present invention.

FIG. 2 illustrates a perspective view of a sensor array housing device according to one embodiment of the present invention.

FIG. 3 illustrates a perspective view of a sensor array housing device according to one embodiment of the present invention.

FIG. 4 illustrates a perspective cross-sectional view of a couplant housing for a sensor array housing device according to one embodiment of the present invention.

FIG. 5 illustrates a perspective view of a roller section of a sensor array housing device according to one embodiment of the present invention.

FIG. 6A illustrates scan results for a foreign object with a focal depth of 20 mm according to one embodiment of the present invention.

FIG. 6B illustrates scan results for a foreign object with a focal depth of 25 mm according to one embodiment of the present invention.

FIG. 6C illustrates scan results for a foreign object with a focal depth of 30 mm according to one embodiment of the present invention.

FIG. 6D illustrates scan results for a foreign object with a focal depth of 35 mm according to one embodiment of the present invention.

FIG. 6E illustrates scan results for a foreign object with a focal depth of 40 mm according to one embodiment of the present invention.

FIG. 6F illustrates scan results for a foreign object with a focal depth of 45 mm according to one embodiment of the present invention.

FIG. 6G illustrates scan results for a foreign object with a focal depth of 50 mm according to one embodiment of the present invention.

FIG. 7 is a schematic diagram of a system of the present invention.

### DETAILED DESCRIPTION

The present invention is generally directed to sensor array probe devices, and more particularly to phased array probe devices able to omnidirectionally articulate about the surface of a test object.

In one embodiment, the present invention is directed to a sensor array housing device, including a stem, a transducer housing section, including an array of ultrasonic sensors, a couplant housing section, wherein the couplant housing section is filled with at least one coupling fluid, an articulating section, attached to a bottom end of the couplant housing section, including a plurality of omnidirectional wheels extending downwardly from the articulating section, wherein the couplant housing section includes a plurality of grooves extending inwardly from an interior surface of an interior chamber of the couplant housing section, wherein the stem is connected to the couplant housing section via one or more bolts or screws, wherein the transducer housing is positioned between the stem and the couplant housing section, wherein a bottom end of the couplant housing section includes an acoustic window, and wherein an interior chamber of the transducer housing section and the interior chamber of the couplant housing section are configured to form a shared hollow interior chamber.

In another embodiment, the present invention is directed to a sensor array housing system, including a scanning device, including a stem, a transducer housing section, including an array of ultrasonic sensors, a couplant housing section, wherein the couplant housing section is filled with at least one coupling fluid, an articulating section, attached to a bottom end of the couplant housing section, including a plurality of omnidirectional wheels extending downwardly from the articulating section, wherein the couplant housing section includes a plurality of grooves extending inwardly from an interior surface of an interior chamber of the couplant housing section, wherein the transducer housing is positioned between the stem and the couplant housing section; and wherein a bottom end of the couplant housing section includes an acoustic window, a robotic arm connected to the stem of the scanning device, and at least one user device in network communication with the scanning device and the robotic arm, wherein the robotic arm is configured to receive positioning commands from the at least one user device to position and move the scanning device for scanning a test object, and wherein the scanning device is configured to receive transducer operational commands from the at least one user device including parameters for operating the array of ultrasonic sensors.

In yet another embodiment, the present invention is directed to a method of nondestructive testing, including providing a scanning device, including a stem, a transducer housing section, including an array of ultrasonic sensors, a couplant housing section, wherein the couplant housing section is filled with at least one coupling fluid, an articulating section, attached to a bottom end of the couplant housing section, including a plurality of omnidirectional wheels extending downwardly from the articulating section, wherein the couplant housing section includes a plurality of grooves extending inwardly from an interior surface of an interior chamber of the couplant housing section, wherein a bottom end of the couplant housing section includes an acoustic window, and at least one user device transmitting commands to the array of ultrasonic sensors to begin a scan of a test object, the array of ultrasonic sensors, in response to the commands, transmitting ultrasonic waves through the at least one coupling fluid and through the acoustic window onto a test object, and the at least one user device transmitting positioning commands to a robotic arm attached to the scanning device, wherein the positioning commands cause the robotic arm to manipulate the physical positioning of the scanning device during the scan of the test object, wherein the ultrasonic waves have a wavelength equal to less than double a height of each of the plurality of grooves.

Non-destructive testing (NDT) is a technique for examining features or flaws of structures without cutting into or otherwise damaging the component. This is particularly relevant in industries such as the aerospace and automotive industries, as both those industries include large machinery that could break down suddenly and catastrophically if previously unseen flaws propagate. Therefore, it is important to use tools to detect such flaws before failure occurs.

Ultrasonic testing is one of the most popular methods of non-destructive testing, also known as non-destructive inspection (NDI) or non-destructive evaluation (NDE). Ultrasonic testing involves the emission of ultrasonic waves into a test material by a transducer and the subsequent sensing of reflecting or transmitted waves by a receiver. In pulse-echo, or reflection, configurations, the ultrasonic energy is introduced to and transmitted through the surface of the test material in waves. The use of such systems typically requires an acoustic medium (e.g., water, gel) to bridge the gap between the transducer and the test material. As the waves propagate through the thickness of the test material, discontinuities within the test material (due to material changes, cracks, delaminations, foreign objects, etc.) cause a reflection of the wave, which can then be detected by the transducer and displayed or characterized. In contrast, in through transmission, or attenuation, configurations, a transducer generates high frequency ultrasonic energy, which is transmitted through one side of a test material and then received by a corresponding receiver on the opposite side of the test material. As the waves propagate through the thickness of the test material, discontinuities within the test material may cause waves in some areas to be slowed or fully attenuated before they reach the receiver. The receiver can then characterize the test material by measuring the degree of attenuation of the ultrasonic wave.

Sensor array devices, including phased array devices, are formed from a plurality of individually fireable transducers (e.g., ultrasonic transducers (i.e., individual piezoelectric elements), eddy current coils, etc.). By varying the timing in which each transducer in the array is fired, the focus distance and/or the angle of an ultrasonic beam generated by the phased array is able to be altered. Sweeping the beam of an ultrasonic transducer at an angle is sometimes known as sectoral scanning. Sectoral scanning is particularly useful in situations in which a straight beam fails to pick up, with high resolution, features within a test object that an angled beam is otherwise able to pick up, typically due to the directionality of the features. These features are sometimes those that are preferentially oriented transverse to the scan direction or that are perpendicular to the surface through-thickness features, and therefore less able to be picked up. Phased arrays are also useful in scanning components more quickly, as the phased array includes many elements that are able to generate a linear beam to sweep across the surface of the test object.

None of the prior art discloses portable linear array housing adapted for sectoral scanning. While portable ultrasonic housing devices are known in the art, these devices lack necessary adaptations necessary for array sectoral scanning. Creating a housing for a sensor array device poses specific challenges both common to other transducers and unique to sensor array devices. For example, in order to capture a high resolution scan, ultrasonic transducers require acoustic couplant to be placed between the transducer and the test object. Ideally, this couplant is contained within the housing, to prevent leakage of water or other materials that possibly damages the test object or causes complications with clean-up later. Additionally, with sectoral-scanning sensor array devices in particular, side lobes and grating lobes of the scan easily reflect on side walls of the housing, causes increased noise and potentially making scan results unreadable. Therefore, what is needed is a housing particularly adapted for sensor array sectoral scanning that is able to mitigate the effects of side lobes and grating lobes. Furthermore, what is needed is for the housing to be able to easily articulate across the device omnidirectionally.

Referring now to the drawings in general, the illustrations are for the purpose of describing one or more preferred embodiments of the invention and are not intended to limit the invention thereto.

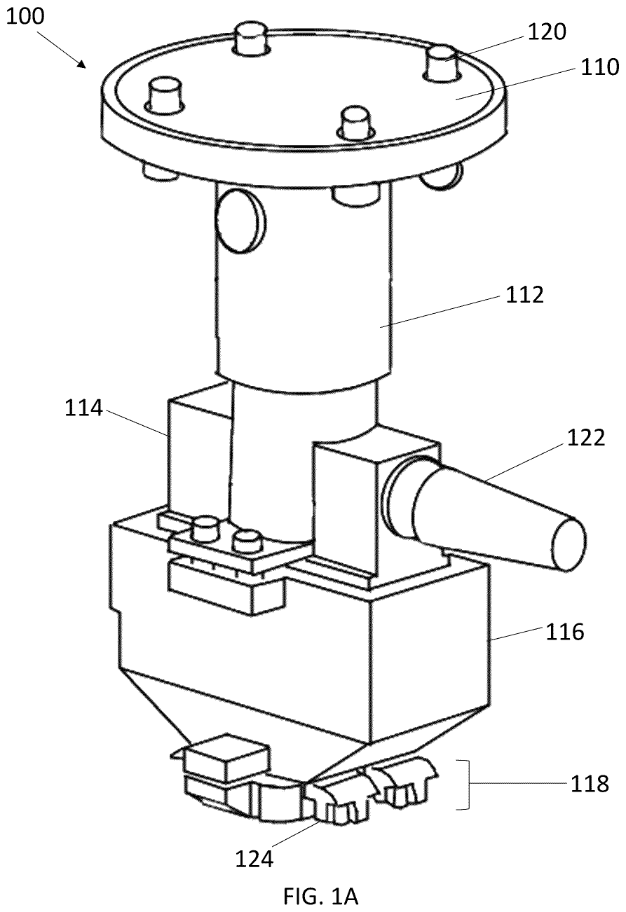

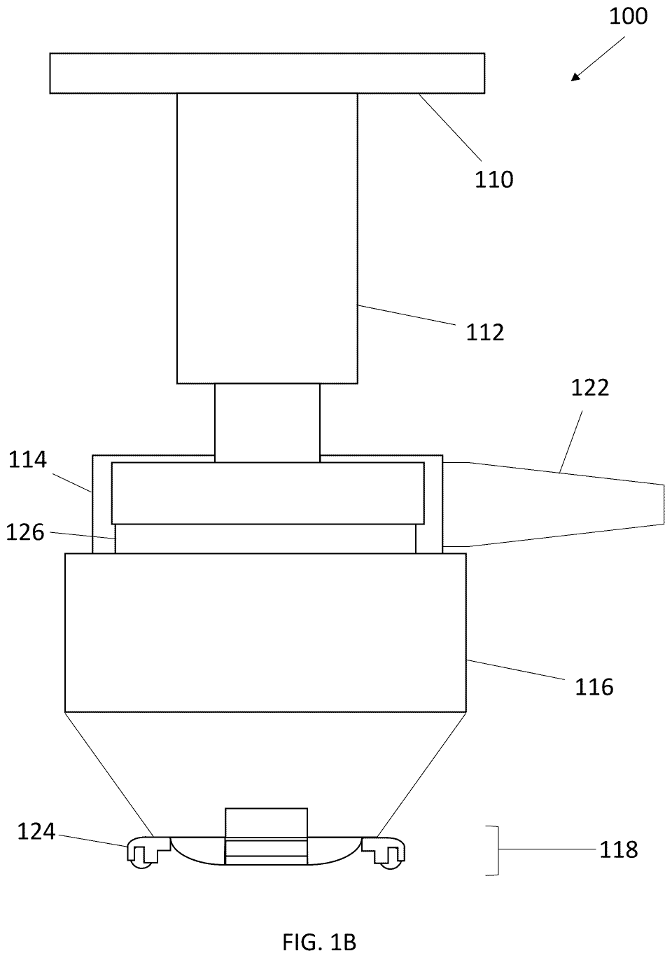

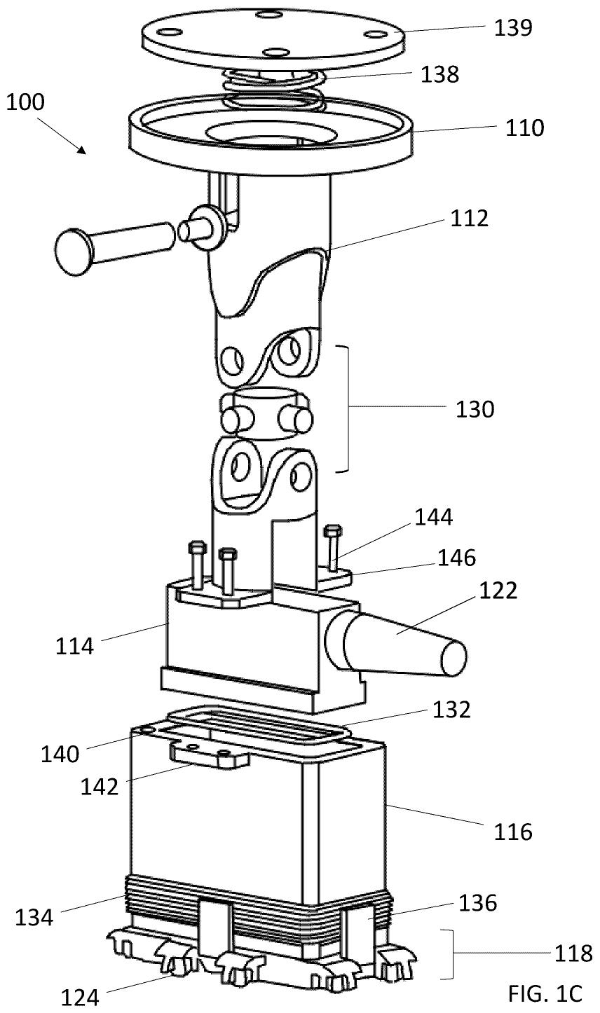

FIG. 1A illustrates a perspective view of a sensor array housing device according to one embodiment of the present invention. A sensor array housing device 100 includes a mounting section 110, a stem 112, a transducer housing section 114, a couplant housing section 116, and an articulating section 118. The mounting section 110 includes one or more connectors 120 able to connect to a robotic arm and/or a translation stage, which is then used to move the sensor array housing device 110 across the surface of a test object. In one embodiment, as shown in FIG. 1A, the connectors 120 include projections extending outwardly from a top surface of the mounting section 110 and operable to fit within corresponding openings on the robotic arm or the translation stage. In another embodiment, the connectors 120 include openings in the top surface of the mounting section 110. In this embodiment, elements including but not limited to screws, bolts, and/or nails are able to be extended through the openings to connect the mounting section 110 to the robotic arm or the translation stage. In one embodiment, the inner surface of the openings are threaded so as to matingly connect with threading on the exterior surface of a screw. One of ordinary skill in the art will understand that while FIG. 1A shows the mounting section 110 as having a substantially circular cross-section, the cross-sectional shape of the mounting section 110 is not intended to be limiting and is able to include, by way of example and not limitation, a rectangular cross-section, a hexagonal cross-section, a trapezoidal cross-section, a pentagonal cross-section, an elliptical cross-section, and/or any otherwise shaped cross-section.

The stem 112 extends downwardly from the mounting section 110. In one embodiment, the stem 112 has a smaller cross-section area than the mounting section 110. In one embodiment, as shown in FIG. 1A, the stem has a substantially cylindrical shape, but one of ordinary skill in the art will understand that such a cylindrical shape is not intended to be limiting according to the present invention. In one embodiment, the sensor array housing device 100 does not include a stem 112 and, instead, the mounting section 110 directly connects to the transducer housing section 114.

The bottom end of the stem 112 connects to the transducer housing section 114. In one embodiment, as shown in FIG. 1B, the interior of the transducer housing section 114 includes a sensor array 126 of a plurality of elements. In one embodiment, the plurality of elements include ultrasonic transducers. In another embodiment, the plurality of elements include eddy current coils. In one embodiment, a cable 122 extends outwardly from an exterior surface of the transducer housing section 114, connecting the array of elements with a power source and/or a function generator (e.g., a pulser receiver).

The bottom end of the transducer housing section 114 is connected to the couplant housing section. The couplant housing section 116 is a sealed chamber containing one or more coupling substances used to acoustically couple the sensor array 126 to the test object. In one embodiment, the couplant housing section 116 is watertight and/or airtight. In one embodiment, the couplant housing section 116 includes at least one port for connecting to a couplant feeding system (e.g., a water pump). In one embodiment, the coupling substance includes a liquid couplant (e.g., water). In one embodiment, the coupling substance includes a solid couplant (e.g., an acoustically coupling polymer block, such as AQUALENE). In one embodiment, the coupling substance includes a gas (e.g., air). Coupling substances are chosen based on an acoustic mismatch between the coupling substance and the test object, the acoustic mismatch between the coupling substance and the transducer, and based on a maximum tolerable attenuation of the transducer signal dependent on the specific scanning application.

The bottom end of the couplant housing section 116 is attached to the articulating section 118. The articulating section 118 is designed to allow the sensor array housing device 100 to easily move along a surface of the test object while performing a scan so as to capture information regarding a larger area of the test object. In one embodiment, the articulating section 118 includes a plurality of ball housings 124 retaining a plurality of balls able to move across the surface of the test object. Advantageously, the balls are preferably able to move omnidirectionally (i.e., roll in any direction in a 360-degree arc), rather than being confined to moving only in one or two directions along a track similar to some prior art inventions.

In one embodiment, the articulating section 118 is a detachable shoe for the transducer housing. Providing use of a shoe allows different articulating sections to be swapped out for each transducer housing as needed. In one embodiment, the articulating 118 is connected to one or more fluid channels. In one embodiment, the one or more fluid channels are connected to one or more pumps configured to pump water or other couplant (e.g., acoustic gel) into the articulating section 118 to facilitate an acoustic path between the acoustic window of the device and the surface of the part being scanned. One of ordinary skill will understand that the couplant being pumped into the articulating section is distinct from the couplant fully contained within the transducer housing itself.

FIG. 1C illustrates a perspective exploded view of a sensor array housing device according to one embodiment of the present invention. As shown in FIG. 1C, in one embodiment, the stem 112 includes a universal joint mechanism 130, including top halves and bottom halves of the stem 112 connected to a central pivot, allowing the stem 112 forward, backward, left, and right as needed.

In one embodiment, the mounting section 110 includes a base plate 139 connected with a spring 138 extending into an opening in the stem 112, providing a spring-loaded universal joint mechanism 130.

In one embodiment, an O-ring 132 (e.g., a 60 durometer O-ring) is positioned between the transducer housing section 114 and the couplant housing section 116, providing a sealed connection between the two components. This allows the two sections to be formed separately and potentially serve as detachable components while still having a waterproof and/or airproof seal.

In one embodiment, an external surface of a lower portion of the couplant housing section 116 includes an outer grooved section 134, including a plurality of ridges. In one embodiment, the articulating section 118 includes one or more clips 136 configured to pivotably move upwardly relative to the articulating section 118. In one embodiment, the one or more clips 136 include one or more ridges on at least one side of the one or more clips 136, and those ridges are configured to matingly engage with the plurality of ridges on the outer grooved section 134 of the couplant housing section 116, providing a further connection mechanism between the articulating section 118 and the couplant housing section 116. In one embodiment, the articulating section 118 is substantially rectangular with a clip 136 extending from substantially the center of each of the four sides of the articulating section 118.

In one embodiment, the couplant housing section 116 includes at least one coupling fluid inlet 140, i.e., a hole defined through a wall of the couplant housing section 116 and extending into a hollow interior of the couplant housing section 116, configured to receive water or other coupling fluid into the couplant housing section 116. In one embodiment, the couplant housing section 116 includes a plurality of coupling fluid inlets 140. In one embodiment, the at least one coupling fluid inlet 116 and/or at least one other hole is able to be connected to a vacuum pump and used to withdraw water or other coupling fluid from the couplant housing section 116.

In one embodiment, one or more platforms 146 extend laterally from a bottom end of the stem 112. In one embodiment, the one or more platforms 146 include one or more holes configured to receive one or more bolts 144 or screws. In one embodiment, one or more platforms 142 extend laterally from a top end of the couplant housing section 116. In one embodiment, two platforms 142 extend from opposite sides of the top end of the couplant housing section 116. In one embodiment, the platforms 142 extending from the couplant housing section 116 are configured to be aligned with the platforms 146 extending from the bottom end of the stem 112. In one embodiment, the platforms 142 of the couplant housing section 116 include one or more holes configured to receive the bolts 144 (e.g., M4 bolts) and/or screws also inserted into the one or more platforms 146 of the stem 112, thereby affixed the bottom end of the stem 112 to the couplant housing section 116. In this embodiment, bottom end of the stem 112 includes a recess sized and shaped to fit the transducer housing section 114, such that the transducer housing section 114 is held in place securely between the stem 112 and the couplant housing section 116.

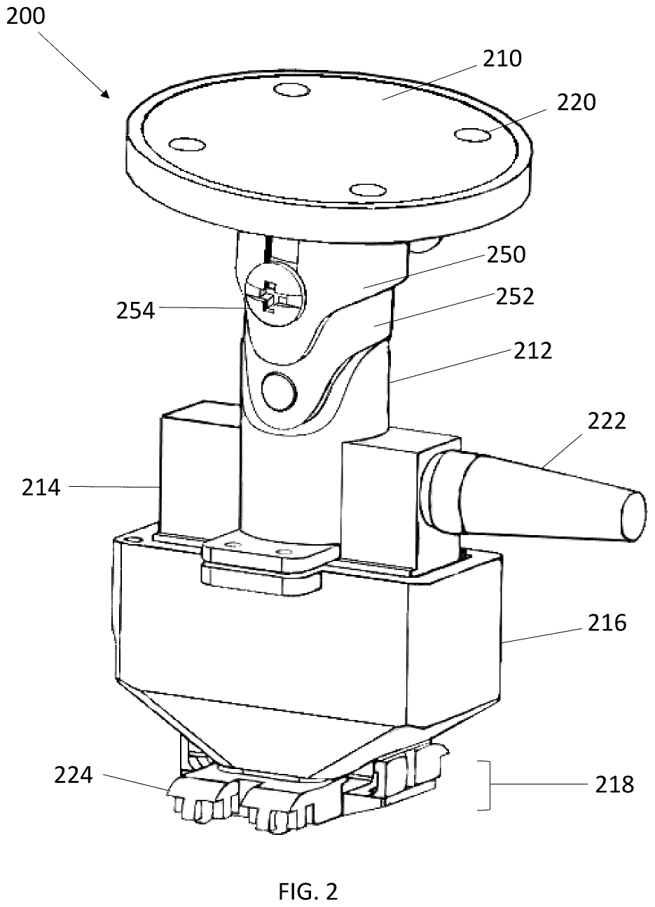

FIG. 2 illustrates a perspective view of a sensor array housing device according to one embodiment of the present invention. Similar to the device shown in FIG. 1A, the sensor array housing device 200 includes a mounting section 210, a stem 212, a transducer housing section 214, a couplant housing section 216, and an articulating section 218. The mounting section 210 includes a plurality of connectors 220 configured to connect with a robotic arm and/or a translation stage. The transducer housing section 214 includes a cable 122 operable to connect the array of elements with a power source and/or function generator. The articulating section 218 includes a plurality of ball housings 224 retaining balls able to move across the surface of a test object. One of ordinary skill in the art will understand that the present invention is also able to utilize omnidirectional wheels in lieu of balls for articulating across the surface of a part.

In one embodiment, the mounting section 210 includes a stem engagement portion 250 configured to surround and engage with a narrowed region 252 of the stem 212. In one embodiment, the stem engagement portion 250 is able to rotate left or right relative to the stem 212, so as to allow the sensor array housing device 200 to access and scan more areas, as it is able to tilt relative to any attached robotic arm or translation stage. In one embodiment, a locking mechanism is engaged to fix the relative orientations of the stem engagement portion 250 and the narrowed region 252 of the stem 212. In one embodiment, the locking mechanism includes at least one screw 254, which, when tightened, fixes the relative orientations of the components of the mechanism and which, when loosened, allows free rotation between the stem engagement portion 250 and the narrowed region 252 of the stem 212. In another embodiment, the sensor array housing device 200 does not include a locking mechanism and the stem engagement portion 250 is freely rotatable about the narrowed region 252 of the stem 212.

In one embodiment, at least one biasing element (e.g., at least one spring) is operable to adjust the relative position of the stem engagement portion 250 and the stem 212, while the screw 254 (or other retaining means) prevents the stem engagement portion 250 from entirely separating from the stem 212. In one embodiment, the stem engagement portion is not freely rotatable, but is translatable, relative to the narrowed region, even when the screw 254, or other retaining means, is disengaged.

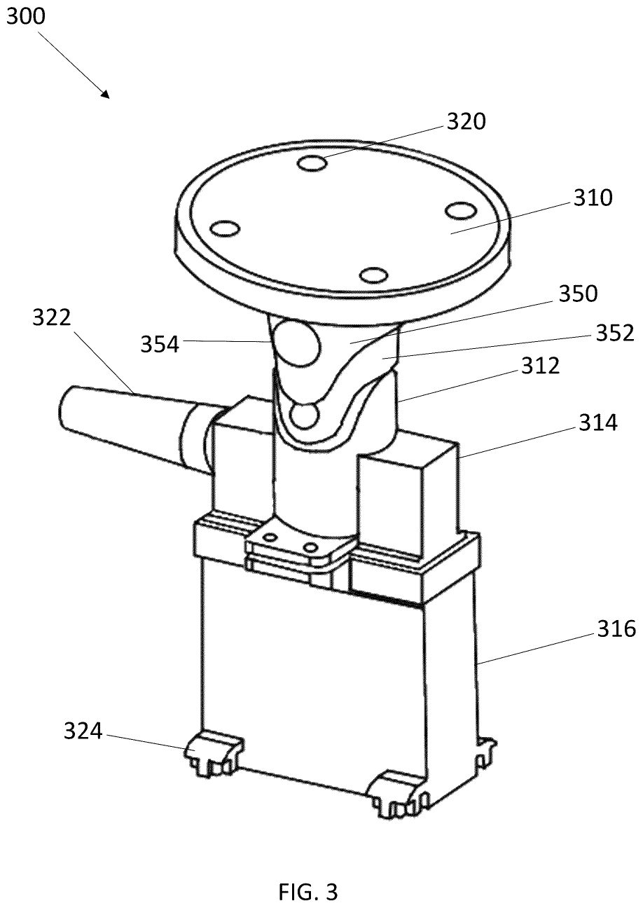

FIG. 3 illustrates a perspective view of a sensor array housing device according to one embodiment of the present invention. Similar to the sensor array housing device 200 shown in FIG. 2, the sensor array housing device 300 in FIG. 3 includes a mounting section 310, a stem 312, a transducer housing section 314, and a couplant housing section 316. The mounting section 310 includes a plurality of attachment points 320 (e.g., openings configured to receive connectors). A cable 322 extends outwardly from the transducer housing section 314 and is able to connect the elements of the sensor array to a power source and/or a function generator.

The mounting section 310 includes a stem engagement portion 350 surrounding a narrowed region 352 of the stem 312 that is pivotable such that the stem engagement portion 350 is able to adjust position relative to the narrowed region 352 of the stem 312 along a single axis. In one embodiment, the stem engagement portion 350 includes a locking mechanism 354 (e.g., a screw) capable of locking the relative positions of the stem engagement portion 350 and the narrowed region 352 of the stem 312.

In one embodiment, at least one biasing element (e.g., at least one spring) is operable to adjust the relative position of the stem engagement portion 350 and the stem 312, while the screw 354 (or other retaining means) prevents the stem engagement portion 250 from entirely separating from the stem 312. In one embodiment, the stem engagement portion is not freely rotatable, but is translatable, relative to the narrowed region, even when the screw 354, or other retaining means, is disengaged.

Unlike the device shown in FIG. 2, the sensor array housing device 300 does not include an articulating section. Instead, the sensor array housing device 300 includes a plurality of wheel housings 324 extending directly from an exterior surface of the couplant housing section 316. In one embodiment, the plurality of wheel housings 324 are integrally formed with the couplant housing section 316. In one embodiment, the couplant housing section 316 is a rectangular prism with an acoustic window extending across a bottom face of the couplant housing section 316. In one embodiment, the couplant housing section 316 houses a solid couplant block (e.g., an AQUALENE block) for coupling an ultrasonic transducer to the surface of a test object. In another embodiment, the couplant housing section 316 houses fluid couplant (e.g., water, air, acoustic gel, etc.). The use of a solid AQUALENE block is likely to require an increased gain (e.g., about 20 dB) relative to the water-filled nozzle. In one embodiment, one or more preamplifiers (e.g., a 128 channel preamplifier) are included in the device and utilized for the ultrasonic sensors to compensate for increased gain from use of the solid AQUALENE block.

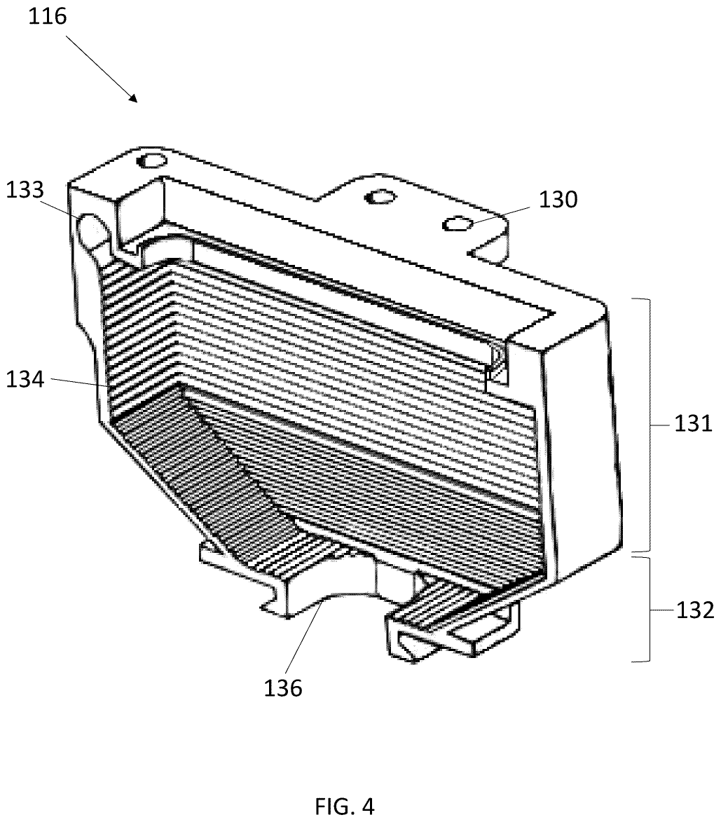

FIG. 4 illustrates a perspective cross-sectional view of a couplant housing for a sensor array housing device according to one embodiment of the present invention. The couplant housing section 116 of the sensor array housing device 112 includes at least one attachment region 130 extending outwardly from a side wall of the couplant housing section 116. The at least one attachment region 130 is configured to connect the couplant housing section 116 to the transducer housing section. In one embodiment, the attachment region 130 includes a plurality of openings configured to receive connecting elements (e.g., screws, nail, bolts, etc.). In one embodiment, the couplant housing section 116 includes two attachment regions 130 extending outwardly from opposite sides of the couplant housing section 116.

In one embodiment, the couplant housing section 116 includes a single internal chamber comprising an initial chamber section 131 nearest to the transducer housing section and having a substantially rectangular cross-section, a second chamber section 132 located below the initial chamber section 131 and having a substantially trapezoidal cross-section, such that couplant housing section is tapered at a bottom end. The bottom of the second chamber section 132 includes an acoustic window 136, which is acoustically transparent or acoustically translucent to emitted waves from the sensor array device, thereby allowing the emitted waves to be transmitted into the test object through the acoustic window 136. Because the acoustic window 136 is positioned at the bottom of a tapered section of the couplant housing section 116, the acoustic window 136 is narrower than width of the initial chamber section 131. The acoustic window 136 in FIG. 4 is directed perpendicular to the length of the sensor array device, which is advantageous particularly when performing sectoral scans with the sensor array housing device. In one embodiment, the acoustic window 136 includes or is covered with at least one lens, wherein the lens is tuned to be substantially acoustically transparent or translucent to the coupling fluid or couplant block in the couplant housing section 116. In one embodiment, the at least one lens is formed from AQUALENE.

The narrowing of the second chamber section 132 and the relatively narrow acoustic window 136 of the device provides a particular advantage. First, the narrow window 136 allows the device to better adapt to the curvature of a test object, especially around tight corners. Additionally, the narrow window 136 allows articulating balls to be placed closer together, thereby allowing the balls to keep contact with the test object even in an area with high curvature. When sectoral scans are performed using the device, the narrow window does not impede the effectiveness of the scan, as the focused beam is able to be angled such that it still exits the narrow window.

Importantly, the sensor arrays must be adjusted in order to adequately focus each of the beams to transmit through the narrow window, rather than being obstructed by the housing itself. This requires shifting the apertures of the beams such that the apertures of all beams are approximately aligned through the center of the window, rather than unaligned at distinct locations. If the focus depth, equal to the distance between the center of the transducer array and the surface of the test object, is set equal to the focal length (f), then the active aperture of each beam is shifted by ±f×tan θ₁=n×p where θ₁ is the angle between a central line normal to the surface of the part and the center of the incident beam. Furthermore, n is equal to the number of elements to be shifted (necessarily a whole number) and p is equal to the pitch of the probe. In a preferred embodiment, the total number of beams produced by the transducer array is equal to five or fewer. In another embodiment, the total number of beams produced by the transducer array is greater than five.

In one embodiment, the initial chamber section 131 is connected to at least one bubble trap 133. If the couplant in the couplant housing section 116 is a liquid, then gas bubbles (e.g., air bubbles) frequently form in the liquid, especially as emitted waves disturb the liquid as they pass through it. Such gaseous bubbles pose an issue, as they potentially form another boundary in the acoustic path that increases the attenuation of the emitted waves, obstructing the path of the exiting beams. The bubble trap 133 helps to counteract this issue by allowing gas to rise and be released within the bubble traps 133.

In one embodiment, the inner surfaces of the initial chamber section 131 and/or the second chamber section 132 include a plurality of grooves 134. In one embodiment, the spacing between the grooves (i.e., between the peaks of each groove) in the plurality of grooves 134 are of at least the same order of magnitude as the wavelength of waves emitted from the sensor array device (i.e., the distance between the grooves is no more than 10 times less than the wavelength of emitted ultrasonic waves). In one embodiment, there is substantially no spacing between the base of each of the plurality of grooves 134. In one embodiment, the height of each of the plurality of grooves 134 (i.e., the distance between the side wall of the chamber and the peak of each groove) is greater than one half of the wavelength of the beams. In one embodiment, the height of each of the grooves is defined as the distance between the side wall of the chamber and the peak of each groove. In another embodiment, the height of each of the grooves is defined as the length between an edge of the base of each groove and the peak of each groove. Therefore, depending on the expected frequency to be used in each scan, the dimensionality of the grooves used should be adjusted (i.e., different devices should be used for scans of different frequencies). However, in order to allow a device to be used for a multiplicity of scans, the grooves must be sized to have a height greater than the maximum wavelength of any relevant scan to be used. Including grooves in the interior of the couplant housing device is important as they reduce the impact of grating lobe signals reflecting off the interior of the couplant housing section and creating problematic artifacts in the scan data. Furthermore, the grooves reduce the impact of unwanted reflections when signals return back to the probe to be detected.

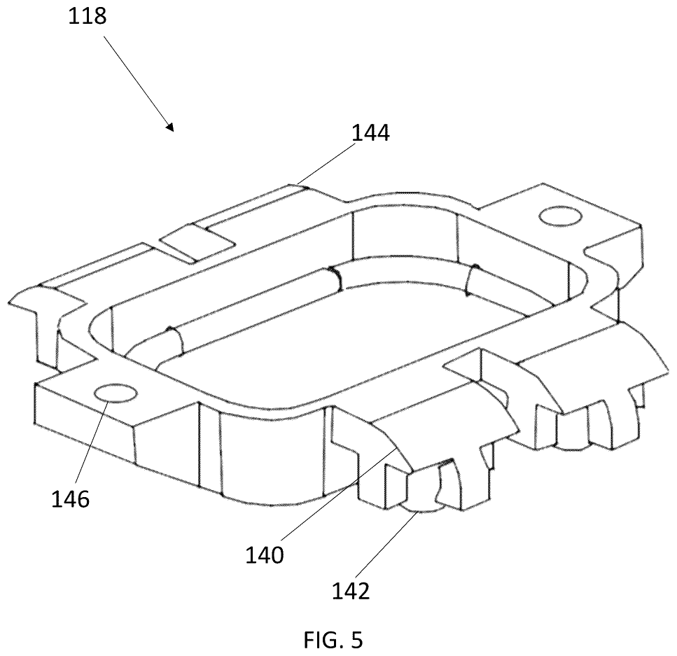

FIG. 5 illustrates a perspective view of a roller section of a sensor array housing device according to one embodiment of the present invention. In one embodiment, the roller section 118 of the sensor array housing device includes one or more attachment regions 146 extending outwardly from a central ring. In one embodiment at least one gasket lines an interior surface of the central ring to prevent liquid from leaking outside the housing. The one or more attachment regions 146 are configured to attach to a couplant housing section of a sensor array housing device. In one embodiment, one or more first wheel housings 140 extend from a first side of the central ring and one or more second wheel housings 144 extend from a second, opposite side of the central ring. The one or more first wheel housings 140 and the one or more second wheel housings 144 each retain a ball, configured for omnidirectional movement (i.e., the ball has at least two degrees of freedom). In another embodiment, the one or more first wheel housing 140 and/or the one or more second wheel housing 144 include at least one wheel with a central axle, such that the at least one wheel has a single degree of freedom. In one embodiment, the one or more first wheel housing 140 and/or the one or more second wheel housing 144 include at least one omnidirectional wheel. In one embodiment, the at least one omnidirectional wheel is configured to lock one or axes of the wheel, such that the at least one omnidirectional wheel is able to have one or two degrees of freedom. Examples of omnidirectional wheels able to be used with the present invention include, but are not limited to, those described in U.S. Pat. Nos. 10,071,596, 11,273,668, and/or 10,369,839.

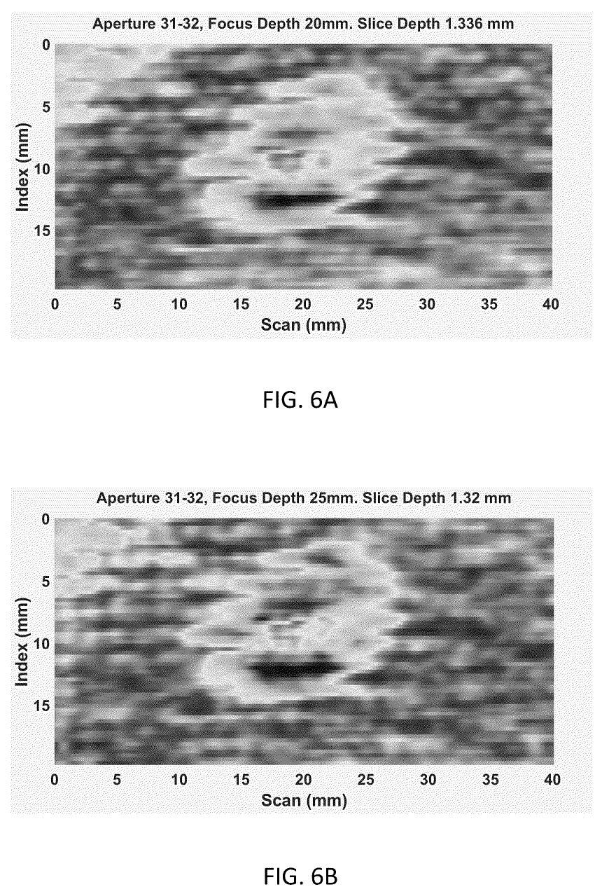

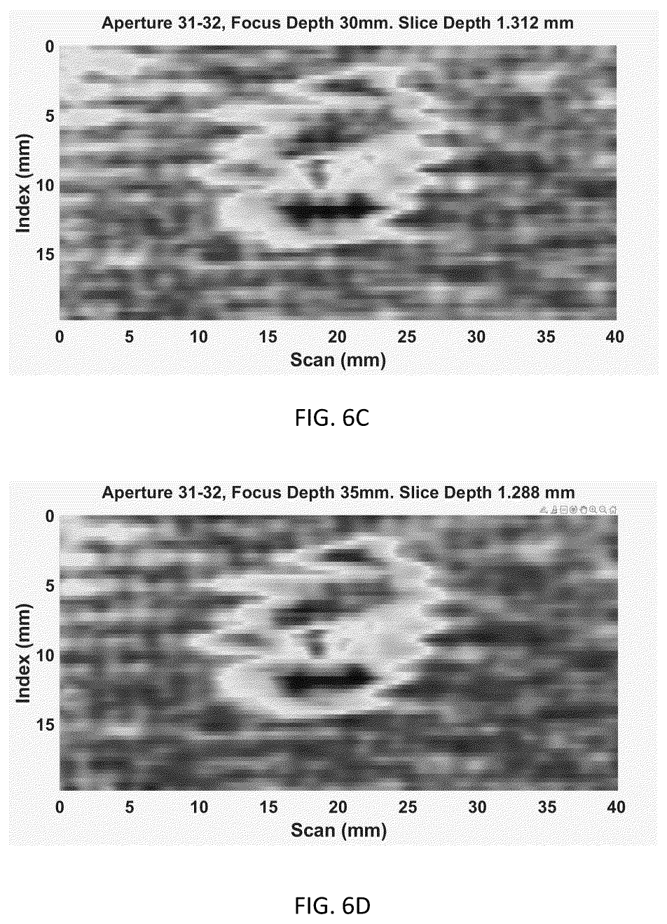

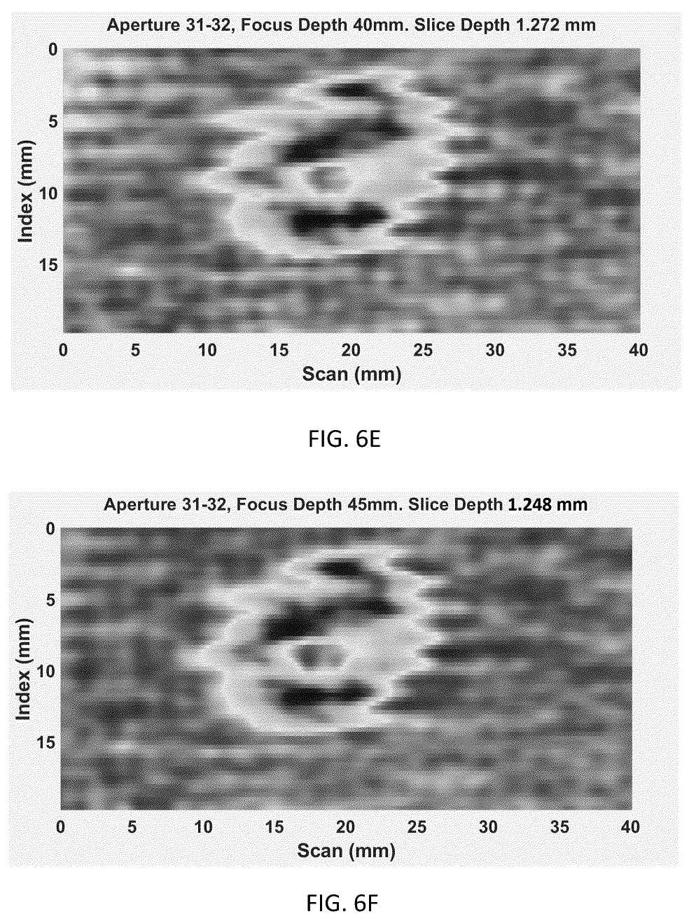

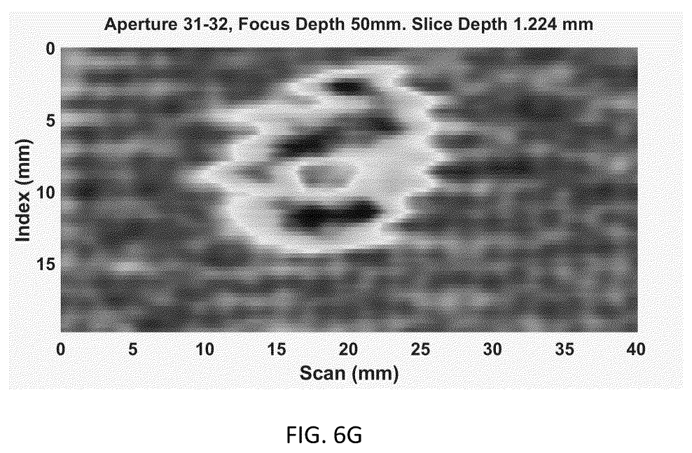

Optimizing resolution for the device requires an investigation of the focal depth of the device. In the case of a 1D linear probe (e.g., with 64 elements), the focus depth is able to be controlled in a primary axis (i.e., along the length of the probe), but cannot be controlled in a secondary axis (i.e., along the width of the probe). However, selection of an optimal focal depth allows for adequate resolution even where the secondary axis cannot be adjusted. FIG. 6A-6G illustrate scan results for a foreign object with varying focal depths according to one embodiment of the present invention. As shown in FIGS. 6A-6G, tests were performed to determine an optimal focal depth of the transducer relative to the surface of the test object based on the clarity of results in analyzing a subsurface feature of the test object (in this case an embedded foreign object). An optimal focal depth of approximately 50 mm was determined (i.e., the transducer was displaced form the surface of the test object by approximately 50 mm). Therefore, in one embodiment, the transducer is positioned approximately 50 mm away from the surface of the test object. More generally, in one embodiment, the focal distance (and therefore the preferred distance between the transducer array and the area of the test object being inspected) is approximately equal to the near-field distance of the individual elements of the transducer array viewed from the width of the transducer array, which provides a natural focus.

In one embodiment, the scanning device of the present invention (and more specifically the transducers in the scanning device of the present invention) are configured to receive commands from at least one user device (e.g., a phone, a laptop, a tablet, etc.) via wired or wireless network communication. Where the scanning device is operable to receive wireless commands, the device includes at least one wireless antenna connected with the transducer array, such that the commands are able to communicate parameters for the scan (e.g., frequency, length of time, wavelength, power, etc.). In one embodiment, at least one user device is also operable to transmit commands to the robotic arm (or translation stage) attached to the scanning device, determining where to position to the robotic arm, how fast to move the robotic arm, timing for when to move the robotic arm, and/or other parameters related to the positioning and physical manipulation of the robotic arm.

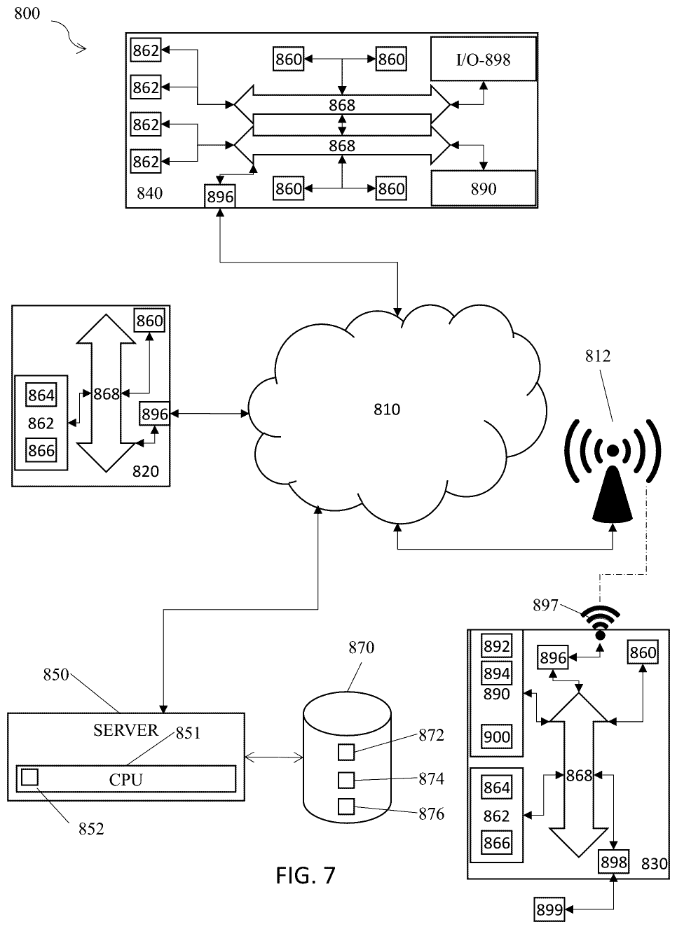

FIG. 7 is a schematic diagram of an embodiment of the invention illustrating a computer system, generally described as 800, having a network 810, a plurality of computing devices 820, 830, 840, a server 850, and a database 870.

The server 850 is constructed, configured, and coupled to enable communication over a network 810 with a plurality of computing devices 820, 830, 840. The server 850 includes a processing unit 851 with an operating system 852. The operating system 852 enables the server 850 to communicate through network 810 with the remote, distributed user devices. Database 870 is operable to house an operating system 872, memory 874, and programs 876.

In one embodiment of the invention, the system 800 includes a network 810 for distributed communication via a wireless communication antenna 812 and processing by at least one mobile communication computing device 830. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, cellular communication, satellite communication, Universal Serial Bus (USB), Ethernet communications, communication via fiber-optic cables, coaxial cables, twisted pair cables, and/or any other type of wireless or wired communication. In another embodiment of the invention, the system 800 is a virtualized computing system capable of executing any or all aspects of software and/or application components presented herein on the computing devices 820, 830, 840. In certain aspects, the computer system 800 is operable to be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of electronic devices including at least a processor and a memory, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in the present application.

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 is operable to additionally include components such as a storage device 890 for storing the operating system 892 and one or more application programs 894, a network interface unit 896, and/or an input/output controller 898. Each of the components is operable to be coupled to each other through at least one bus 868. The input/output controller 898 is operable to receive and process input from, or provide output to, a number of other devices 899, including, but not limited to, alphanumeric input devices, mice, electronic styluses, display units, touch screens, signal generation devices (e.g., speakers), or printers.

By way of example, and not limitation, the processor 860 is operable to be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 840 in FIG. 7, multiple processors 860 and/or multiple buses 868 are operable to be used, as appropriate, along with multiple memories 862 of multiple types (e.g., a combination of a DSP and a microprocessor, a plurality of microprocessors, one or more microprocessors in conjunction with a DSP core).

Also, multiple computing devices are operable to be connected, with each device providing portions of the necessary operations (e.g., a server bank, a group of blade servers, or a multi-processor system). Alternatively, some steps or methods are operable to be performed by circuitry that is specific to a given function.

According to various embodiments, the computer system 800 is operable to operate in a networked environment using logical connections to local and/or remote computing devices 820, 830, 840 through a network 810. A computing device 830 is operable to connect to a network 810 through a network interface unit 896 connected to a bus 868. Computing devices are operable to communicate communication media through wired networks, direct-wired connections or wirelessly, such as acoustic, RF, or infrared, through an antenna 897 in communication with the network antenna 812 and the network interface unit 896, which are operable to include digital signal processing circuitry when necessary. The network interface unit 896 is operable to provide for communications under various modes or protocols.

In one or more exemplary aspects, the instructions are operable to be implemented in hardware, software, firmware, or any combinations thereof. A computer readable medium is operable to provide volatile or non-volatile storage for one or more sets of instructions, such as operating systems, data structures, program modules, applications, or other data embodying any one or more of the methodologies or functions described herein. The computer readable medium is operable to include the memory 862, the processor 860, and/or the storage media 890 and is operable be a single medium or multiple media (e.g., a centralized or distributed computer system) that store the one or more sets of instructions 900. Non-transitory computer readable media includes all computer readable media, with the sole exception being a transitory, propagating signal per se. The instructions 900 are further operable to be transmitted or received over the network 810 via the network interface unit 896 as communication media, which is operable to include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system 800.

In one embodiment, the computer system 800 is within a cloud-based network. In one embodiment, the server 850 is a designated physical server for distributed computing devices 820, 830, and 840. In one embodiment, the server 850 is a cloud-based server platform. In one embodiment, the cloud-based server platform hosts serverless functions for distributed computing devices 820, 830, and 840.

In another embodiment, the computer system 800 is within an edge computing network. The server 850 is an edge server, and the database 870 is an edge database. The edge server 850 and the edge database 870 are part of an edge computing platform. In one embodiment, the edge server 850 and the edge database 870 are designated to distributed computing devices 820, 830, and 840. In one embodiment, the edge server 850 and the edge database 870 are not designated for distributed computing devices 820, 830, and 840. The distributed computing devices 820, 830, and 840 connect to an edge server in the edge computing network based on proximity, availability, latency, bandwidth, and/or other factors.

It is also contemplated that the computer system 800 is operable to not include all of the components shown in FIG. 7, is operable to include other components that are not explicitly shown in FIG. 7, or is operable to utilize an architecture completely different than that shown in FIG. 7. The various illustrative logical blocks, modules, elements, circuits, and algorithms described in connection with the embodiments disclosed herein are operable to be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

The invention claimed is:

1. A sensor array housing device, comprising:
a stem;
a transducer housing section, including an array of ultrasonic sensors;
a couplant housing section, wherein the couplant housing section is filled with at least one coupling fluid;
an articulating section, attached to a bottom end of the couplant housing section, including a plurality of omnidirectional wheels extending downwardly from the articulating section;
wherein the couplant housing section includes a plurality of grooves extending inwardly from an interior surface of an interior chamber of the couplant housing section;
wherein the stem is connected to the couplant housing section via one or more bolts or screws;
wherein the transducer housing is positioned between the stem and the couplant housing section;
wherein a bottom end of the couplant housing section includes an acoustic window; and
wherein an interior chamber of the transducer housing section and the interior chamber of the couplant housing section are configured to form a shared hollow interior chamber.

2. The sensor array housing device of claim 1, wherein the couplant housing section includes a tapered bottom section, and wherein the acoustic window is a narrow hole in the bottom end of the tapered bottom section.

3. The sensor array housing device of claim 1, wherein the array of ultrasonic sensors is configured to be fired at a wavelength equal to less than double a height of each of the plurality of grooves.

4. The sensor array housing device of claim 1, wherein a top end of the stem includes a mounting section configured to connect with a robotic arm or a translation stage.

5. The sensor array housing device of claim 1, wherein the stem includes a universal joint configured to allow a top portion of the stem to bend forward, back, right, or left relative to a bottom portion of the stem.

6. The sensor array housing device of claim 1, the acoustic window is covered with a lens, wherein the lens is configured to be acoustically transparent or translucent to the at least one coupling fluid.

7. The sensor array housing device of claim 7, wherein the lens is formed from AQUALENE.

8. The sensor array housing device of claim 1, wherein a plurality of external grooves extend outwardly from a portion of an exterior surface of the couplant housing section, wherein the plurality of external grooves are configured to matingly connect with a corresponding set of grooves on one or more clips, and wherein the one or more clips extend upwardly from the articulating section.

9. A sensor array housing system, comprising:
a scanning device, including:
a stem;
a transducer housing section, including an array of ultrasonic sensors;
a couplant housing section, wherein the couplant housing section is filled with at least one coupling fluid;
an articulating section, attached to a bottom end of the couplant housing section, including a plurality of omnidirectional wheels extending downwardly from the articulating section;
wherein the couplant housing section includes a plurality of grooves extending inwardly from an interior surface of an interior chamber of the couplant housing section;
wherein the transducer housing is positioned between the stem and the couplant housing section; and
wherein a bottom end of the couplant housing section includes an acoustic window;
a robotic arm connected to the stem of the scanning device; and
at least one user device in network communication with the scanning device and the robotic arm;
wherein the robotic arm is configured to receive positioning commands from the at least one user device to position and move the scanning device for scanning a test object; and
wherein the scanning device is configured to receive transducer operational commands from the at least one user device including parameters for operating the array of ultrasonic sensors.

10. The system of claim 9, wherein the array of ultrasonic sensors is configured to be fired at a wavelength equal to less than double a height of each of the plurality of grooves.

11. The system of claim 9, wherein the couplant housing section includes a tapered bottom section, and wherein the acoustic window is a narrow hole in the bottom end of the tapered bottom section.

12. The system of claim 9, wherein the stem includes a universal joint configured to allow a top portion of the stem to bend forward, back, right, or left relative to a bottom portion of the stem.

13. The system of claim 9, wherein the acoustic window is covered with a lens, wherein the lens is configured to be acoustically transparent or translucent to the at least one coupling fluid.

14. The system of claim 13, wherein the lens is formed from AQUALENE.

15. The system of claim 9, wherein a plurality of external grooves extend outwardly from a portion of an exterior surface of the couplant housing section, wherein the plurality of external grooves are configured to matingly connect with a corresponding set of grooves on one or more clips, and wherein the one or more clips extend upwardly from the articulating section.

16. The system of claim 9, wherein the operation commands include a length of time for scanning the test object, and/or a wavelength or frequency with which to scan the test object.

17. A method of nondestructive testing, comprising:
providing a scanning device, comprising:
a stem;
a transducer housing section, including an array of ultrasonic sensors;
a couplant housing section, wherein the couplant housing section is filled with at least one coupling fluid;
an articulating section, attached to a bottom end of the couplant housing section, including a plurality of omnidirectional wheels extending downwardly from the articulating section;
wherein the couplant housing section includes a plurality of grooves extending inwardly from an interior surface of an interior chamber of the couplant housing section;
wherein a bottom end of the couplant housing section includes an acoustic window; and
at least one user device transmitting commands to the array of ultrasonic sensors to begin a scan of a test object;
the array of ultrasonic sensors, in response to the commands, transmitting ultrasonic waves through the at least one coupling fluid and through the acoustic window onto a test object; and
the at least one user device transmitting positioning commands to a robotic arm attached to the scanning device, wherein the positioning commands cause the robotic arm to manipulate the physical positioning of the scanning device during the scan of the test object;
wherein the ultrasonic waves have a wavelength equal to less than double a height of each of the plurality of grooves.

18. The method of claim 17, wherein the acoustic window is covered with a lens, wherein the lens is configured to be acoustically transparent or translucent to the at least one coupling fluid.

19. The method of claim 17, wherein the lens is formed from AQUALENE.

20. The method of claim 17, wherein the couplant housing section includes a tapered bottom section, and wherein the acoustic window is a narrow hole in the bottom end of the tapered bottom section.
